(19) United States
(12) Patent Application Publication
(10) Pub. No.: US 2012/0036139 A1
(43) Pub. Date: Feb. 9, 2012

(54) CONTENT RECOMMENDATION DEVICE, METHOD OF RECOMMENDING CONTENT, AND COMPUTER PROGRAM PRODUCT

(75) Inventors: Masayuki Okamoto, Kanagawa (JP); Masaru Suzuki, Kanagawa (JP); Daisuke Ajitomi, Kanagawa (JP); Masahiro Sekine, Tokyo (JP); Yasukazu Higuchi, Kanagawa (JP)

(73) Assignee: KABUSHIKI KAISHA TOSHIBA, Tokyo (JP)

(21) Appl. No.: 13/241,859

(22) Filed: Sep. 23, 2011

Related U.S. Application Data
(63) Continuation of application No. PCT/JP2010/054255, filed on Mar. 12, 2010.

(30) Foreign Application Priority Data
Mar. 31, 2009 (JP) 2009-087991

(51) Int. Cl. G06F 17/30

(52) U.S. Cl. 707/749; 707/E17.137

(57) ABSTRACT

According to one embodiment, a content recommendation device includes a storage to store metadata; a display unit to display a plurality of pieces of content information corresponding to the contents; a selection unit to select first content information displayed on the display unit and second content information to be displayed after the first content information; an extraction unit to extract a keyword based on a co-occurrence relation between the metadata of the first and second content information; a generation unit to generate a search query based on the keyword; an acquisition unit to acquire third content information from an external database using the search query; a calculation unit configured to calculate similarity between the second and third content information by using the metadata of the second and third content information; and an arrangement control unit to arrange the third content information on the display unit based on the similarity.

### CROSS-REFERENCE TO RELATED APPLICATIONS

This application is a continuation of PCT international application Ser. No. PCT/JP2010/054255 filed on Mar. 12, 2010 which designates the United States, and which claims the benefit of priority from Japanese Patent Application No. 2009-087991, filed on Mar. 31, 2009; the entire contents of which are incorporated herein by reference.

### FIELD

Embodiments described herein relate generally to a content recommendation device, a method of recommending a content, and a computer program product.

### BACKGROUND

There is a demand in which a user wants to find without any awareness and easily retrieve a content relating to a content of a video that is currently watched, a Web page that is currently browsed, or the like. Thus, there is a technique of searching for and recommending a content relating to the content that is currently watched or browsed.

A conventional content recommendation device generates a program-related information page by arranging information of each broadcast program in descending order of relevance degrees that are calculated based on the cast, the title, and the genre.

However, according to the conventional technique, there is a possibility that a related content recommended next cannot be sufficiently acquired, depending on the content selected by a user. In such a case, the related content that is displayed to the user is same all the time, which results in no discovery of a new content for the user.

### BRIEF DESCRIPTION OF THE DRAWINGS

FIG. 1 is a functional block diagram illustrating a content recommendation device 100;

FIG. 2 is a diagram illustrating an example of a display screen of content information at time t−1 (at the previous time);

FIG. 3 is a diagram illustrating an example of metadata that is stored in a storage 102;

FIG. 4 is a diagram illustrating an example of a display screen of content information at time t (at the current time);

FIG. 5 is a diagram illustrating the generation sequence of a search query in a query generating section 111;

FIG. 6 is a diagram illustrating an example of the final arrangement of content information in a “person-related” area at time t (at the current time);

FIG. 7 is a flowchart illustrating the operation of the content recommendation device 100; and

FIG. 8 is a diagram illustrating an example of a display screen of content information at time t (at the current time), according to a modification of the embodiment.

### DETAILED DESCRIPTION

According to one embodiment, a content recommendation device includes a storage configured to store therein metadata of a plurality of contents; a display unit configured to display the contents as a plurality of pieces of content information recognizable by a user; a selection unit configured to select first content information displayed on the display unit and second content information to be displayed after the first content information; an extraction unit configured to extract a keyword based on a co-occurrence relation between the metadata of the first content information and the metadata of the second content information; a generation unit configured to generate a search query based on the keyword; an acquisition unit configured to acquire third content information from an external database using the search query; a calculation unit configured to calculate similarity between the second content information and the third content information by using the metadata of the second and third content information; and an arrangement control unit configured to arrange the third content information on the display unit based on the similarity.

Various embodiments will be described hereinafter with reference to the accompanying drawings.

A content according to this embodiment is a video such as a TV program or a moving image on the Internet to which metadata is added. The metadata includes data that is extracted and converted into a format that can be processed as text data using existing multimedia processing technique such as speech recognition, in addition to data that is described as text data such as an electronic program guide (EPG) or MPEG-7. However, this embodiment can be similarly applied to a still screen or the like, such as a Web page or an EXIF in which metadata is written, as well.

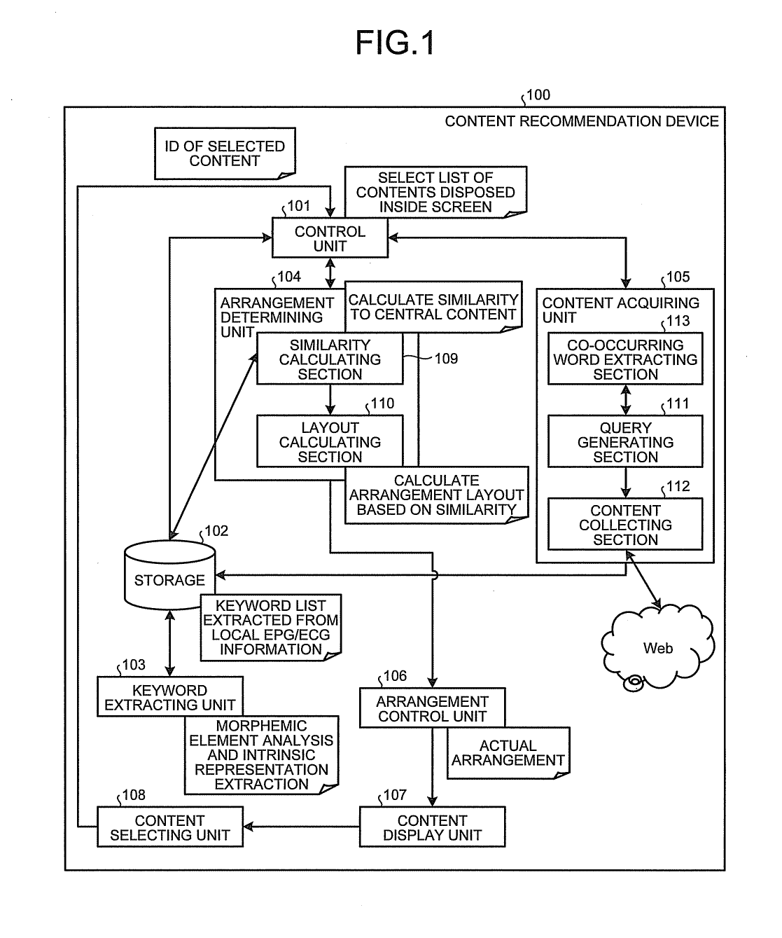

FIG. 1 is a functional block diagram illustrating a content recommendation device 100 according to this embodiment. Here, content information represents information of which a content can be recognized by a user (for example, a title or a genre), and a thumbnail image may be added thereto when it can be used after recording or the like. In the case of a moving image on the network, since a thumbnail image can be acquired separately from a moving image main body, this thumbnail image may be added to the content information.

A plurality of pieces of the content information is arranged on one screen. Then, when a user selects one piece of the content information from the plurality of pieces of the content information, a control unit 101 selects and determines related content information relating to the selected piece of the content information so as to be disposed within a display area.

The content recommendation device 100 includes: the control unit 101; a storage 102 that stores therein the metadata of each content; a keyword extracting unit 103 that extracts a keyword having a specific attribute such as a person's name from the metadata stored in the storage 102 and stores it as new metadata; an arrangement determining unit 104 that determines the arrangement layout of pieces of content information; a content acquiring unit 105 that acquires content information from an external database such as an EPG or a database disposed on the Internet; an arrangement control unit 106 that controls the arrangement of the content information based on the arrangement layout determined by the arrangement determining unit 104; a content display unit 107 that displays, for a user, a list of pieces of content information arranged by the arrangement control unit 106; and a content selecting unit 108 that provides a user interface allowing a user to select the related content information displayed on the content display unit 107 and inputs the result of selection to the control unit 101.

The arrangement determining unit 104 includes: a similarity calculating section 109 that calculates the degree of similarity between contents; and a layout calculating section 110 that determines the arrangement layout of a content based on the degree of similarity calculated by the similarity calculating section 109. The content acquiring unit 105 includes: a query generating section 111 that generates a search query used for acquiring content information; a content collecting section 112 that collects related content information in accordance with the generated search query; and a co-occurring word extracting section 113 that extracts a keyword that co-occurs in the metadata of contents and inputs the extracted keyword to the query generating section 111 in a case where the amount of the description of metadata that is written in the content information is small. Furthermore, when the keyword co-occurrence relation is to be acquired, it may be acquired based on that the attributes of the metadata are different from each other.

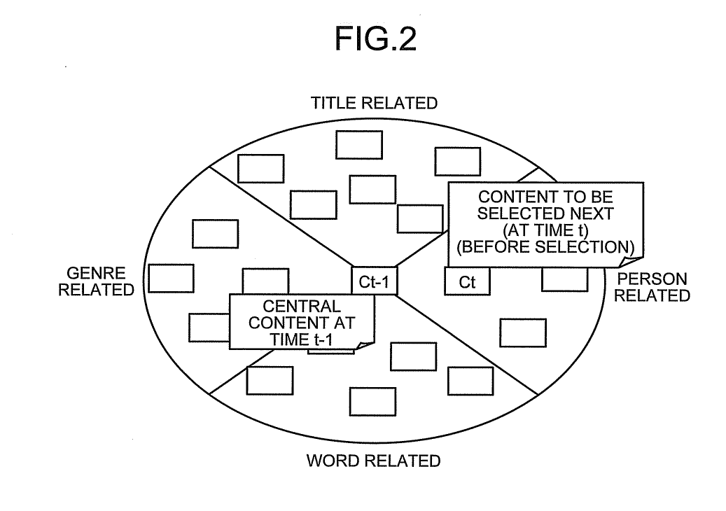

FIG. 2 is a diagram illustrating an example of a display screen of the content display unit 107 at time t−1. At time t−1, the content information (central content information Ct−1) selected with the content selecting unit 108 is displayed at the center of the screen, and the related content information is displayed on the periphery thereof. In the display area of the related content information, the content information relating to the central content information Ct−1 is displayed based on viewpoints that are divided into a plurality of areas. In this embodiment, the display area is formed in an oval shape and is divided into four areas. As the viewpoints, four types including a title, a person, a word, and a genre are used. In addition, although the content information is displayed only within the oval in FIG. 2, it may be configured such that the content information is also drawn outside the oval, and the content information arranged outside the oval is displayed when it is disposed within the display area through a scroll operation.

The similarity calculating section 109 calculates a similarity score between the central content information Ct−1 and the related content information in each area for each viewpoint. For example, in a case where a similarity score between a content 1 and a content 2 is to be calculated for the viewpoint of the person, assuming that three persons X, Y, and Z are extracted from the content information of the content 1, and four persons X, Y, V, and W are extracted from the content information of the content 2 through the process of the keyword extracting unit 103 to be described below, the number of persons who are common to both of the contents, that is, two, is calculated as the similarity score. In this embodiment, although the number of matching words is used as the score, another calculation method such as a method in which the matching ratio is used as the score by using the gradient of scores according to the appearing order of words or partial matching of the character strings of words may be used.

The layout calculating section 110 calculates coordinates for each area such that the related content information of each area is arranged in accordance with the similarity score for each viewpoint, in other words, as the similarity score of a related content is higher, the related content information is arranged closer to the center. In this embodiment, although the arrangement in each area is calculated such that the arrangements do not overlap each other in accordance with a repulsive force using a spring model, the arrangements may be configured so as to overlap each other.

The arrangement control unit 106 actually arranges the central content information Ct−1 and the related content information for each area in accordance with the calculated arrangement position on the content display unit 107.

By arranging the content information as such, a user can understand that, the closer the arrangement position of related content information is to the central content information Ct−1, the stronger the relevancy between the related content information and the central content information Ct−1 for each viewpoint is.

Although the display area is illustrated to be limited to the inside of the oval in FIG. 2, the related content information may be arranged outside the oval. In addition, in this embodiment, although the display area has an oval shape and the number of the types of areas is four, the shape of the display area and the number of the types of areas are not limited thereto. Each area is independent, and hereinafter, the arrangement of the related content information for the “person related” area out of the four areas will be focused in the description.

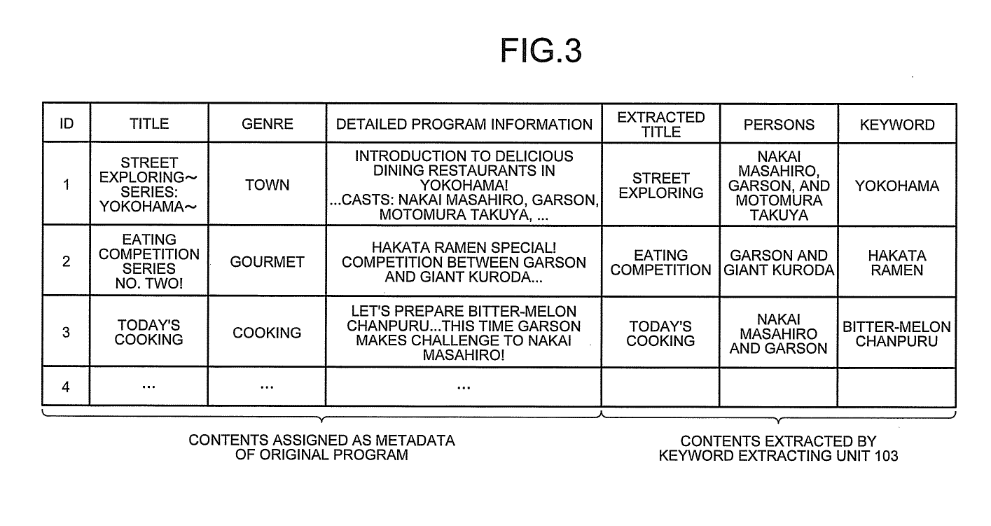

The metadata of each content is stored in the storage 102. FIG. 3 is a diagram illustrating an example of the metadata that is stored in a storage 102. An ID that is unique to each content, a title, a genre, and detailed program information are assigned as original program metadata, and additionally, attributes such as a broadcast station, broadcast date and time, and a program length are similarly assigned.

In addition, in such description, keywords such as a program title not including a sub title, a person's name, and a geographical name that serve as keys to a user determining the relevancy of the content are included, and each thereof is extracted through morphological analysis and named entity extraction of the keyword extracting unit 103. As such stored portions, in this embodiment, as the storage destinations of each extraction result, three types including the title, the person, and the keyword that are extracted are used. Here, a keyword represents a type that is necessary for the relevancy of the program, out of morphemes or named entities which are not included in any of the titles and the persons. In FIG. 3, metadata that is originally given as the program metadata when the program information is acquired and metadata extracted by the keyword extracting unit 103 are written.

Hereinafter, a case will be described in which central content information Ct−1 at time t−1 illustrated in FIG. 2 is ID1 “street exploring” illustrated in FIG. 3, and content information Ct selected as an area “person related” by a user using the content selecting unit 108 at time t is ID2 “eating competition” illustrated in FIG. 3.

First, when the user selects Ct, the control unit 101 determines the arrangement of each piece of content information by using the arrangement determining unit 104. The arrangement determining unit 104 sets Ct as the central content information at time t and, next, calculates a similarity score between the central content information Ct and each of the other sets of content information by using the similarity calculating section 109.

As a method for calculating the similarity, matching of the extracted keywords corresponding to each viewpoint is performed, and the number of matches is set as a similarity score. In the case of the “person-related” area, the similarity score is calculated on the basis of the number of matching keywords included in the “person” item in the storage 102.

The layout calculating section 110 determines the arrangement position within the “person-related” area by using the similarity that is calculated by the similarity calculating section 109. At this time, the similarity score is normalized for the arrangement such that the central content information Ct−1 at the previous time (at time t−1) is disposed within the screen. This is because in a case where the Ct−1 is deviated from the “person-related” display area, it is not visible for a user, and the user cannot return to the content at the previous time (at time t⁻1), thereby making it difficult for the user to understand the content relevancy between Ct and Ct−1.

The control unit 101 checks the number of pieces of the content information that are disposed within a predetermined area in a case where the content information is arranged at time t. When the number of pieces of the content information is less than a threshold value that is determined in advance, the control unit 101 instructs the content acquiring unit 105 to acquire the content information from an external database that is on a Web or the like.

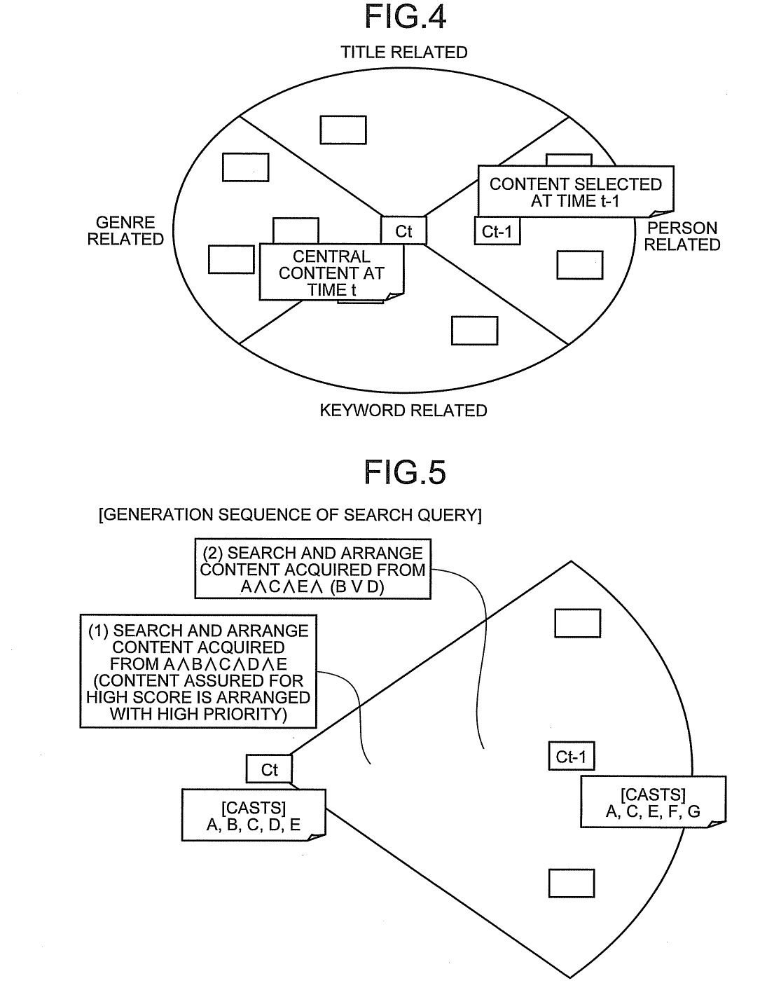

FIG. 4 is a diagram illustrating an example of a display screen of contents at time t (current time). Herein, the number of pieces of the displayed content information is small as compared with that shown in FIG. 2, and accordingly, it is difficult to lead a user to watching of the next content (in other words, a content at time t+1). Therefore, the content acquiring unit 105 acquires related content information from the external database, and the control unit 101 displays the acquired content information on an available space of the screen.

In the content acquiring unit 105, first, a search query is generated by the query generating section 111. FIG. 5 is a diagram illustrating the generation sequence of a search query in the query generating section 111. In a case where five persons A, B, C, D, and E are included in the metadata of the central content information Ct, and five persons A, C, E, F, and G are included in the metadata of Ct−1, the persons A, C, and E are common to both contents. Accordingly, in order to represent the relation with the selected information Ct−1 at the previous time (at time t−1), it is preferable that contents including A, C, and E are searched for and are arranged between Ct and Ct−1. Search queries in this case are a first query of A Λ B Λ C Λ D Λ E that is the most similar to the currently selected content Ct, and a second query of (A Λ C Λ E) Λ (B v D).

Then, the search result based on the first query of A Λ B Λ C Λ D Λ E is arranged in the nearest neighbor of Ct, and the search result based on the second query of (A Λ C Λ E) Λ (B v D) that is not included in the result of the first query is arranged to the outer side thereof.

The content collecting section 112 acquires content information from the external database based on the search query that is generated by the query generating section 111. In this embodiment, a moving image on the Internet is acquired through an Internet search. The metadata of the acquired moving image on the Internet is added to the storage 102, and keywords are extracted from the metadata by the keyword extracting unit 103, whereby the metadata is expanded.

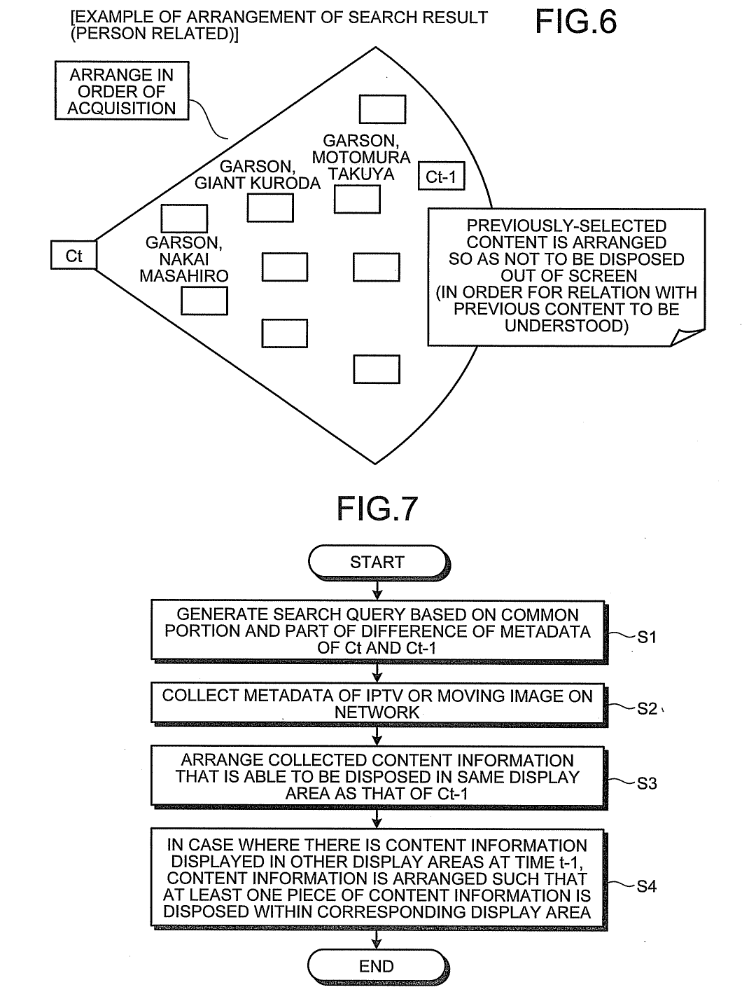

The control unit 101 calls the arrangement determining unit 104 for each piece of collected content information and instructs the arrangement determining unit 104 to determine arrangement positions. Although the arrangement using the layout calculating section 110 is performed in the order of the acquisition of contents, in a case where the search result based on each query can be arranged in the same area, a search result, for which the arrangement is supposed to be closer to the central content information Ct, to be more specific, a search result based on the query of A Λ B Λ C Λ D Λ E is arranged with high priority over the search result based on the query of (A Λ C Λ E) Λ (B v D). FIG. 6 is a diagram illustrating an example of the final arrangement of contents in a “person-related” area at time t (at the current time).

As illustrated in FIG. 6, even in a case where the number of arrangement pieces of the content information, which is initially available (in other words, the content information that is stored in the storage 102), is insufficient, a sufficient number of pieces of the content information can be arranged between Ct and Ct−1 by collecting appropriate content information from the external database, so as to be recommended to a user.

In addition, for the other areas, a search is performed with the same conditions, and content information is arranged. In these areas, the content information is arranged such that at least one content is disposed within each area.

FIG. 7 is a flowchart illustrating the operation of the content recommendation device 100 according to an embodiment. First, in the display area (the “person-related” area illustrated in FIG. 4) in which the watched content information Ct−1 at time t−1 is arranged at time t, the query generating section 111 generates a search query based on a common portion (A Λ C Λ E illustrated in FIG. 5) of the metadata of the watching content information Ct at the current time (at time t) and the watched content information Ct−1 at time t−1 and a part of a difference thereof (B v D v F v G illustrated in FIG. 5) (step S1). The content collecting section 112 collects metadata of IPTV (Internet Protocol Television) or a moving image on the network from the external database by using the search query acquired in step S1 (step S2).

The layout calculating section 110 arranges pieces of the content information collected from the external database, which is able to be disposed within the same display area (the “person-related” area illustrated in FIG. 4) as that of Ct−1 (step S3).

In a case where there is content information displayed in the other display areas at time t−1, the content information is arranged such that at least one piece of the content information is disposed within the corresponding display area (step S4).

In this manner, in a case where the related contents originally stored in the storage 102 are insufficient, a problem in that a related content is not reflected on the display even when the related content is actually present in the external database can be solved.

### Modification 1

In addition, a priority of the display may be set to the search query. In such a case, in a case where not only a video recorded in the device but also a moving image that is present on the Internet is searched for and displayed as the related content information, content information having a higher priority to be displayed on the current screen can be presented first, whereby the following problem that arises when a moving image on the network is searched for and presented can be solved: a user has to wait until the similarity is calculated and displayed after performing a whole search. In addition, the priority of the display can be adjusted in accordance with an estimated amount of content information to be arranged between Ct and Ct−1 that is obtained based on the priority and the time required for acquiring the search result in the past.

### Modification 2

A difference between the terms of an EPG that is the metadata of a TV program and an electronic contents guide (ECG) that is the metadata of a content on the Internet may be absorbed using a language thesaurus. For example, in a case where the same person is described as “Motomura Takuya” in a TV program and is described as his nickname “Moto Taku” in a moving image on the network, it can be checked that both terms represent the same person by looking up a thesaurus dictionary that is prepared in advance. In addition, it may be configured such that, as an expansion of a thesaurus, “Nakai Masahiro” and “Motomura Takuya” are represented as members of the same group by using a language table that represents a hierarchical relationship, or, for example, a broader concept of a quiz program or a food program can be represented as a variety program by using a linguistic ontology that represents a system such as a broader concept and a narrower concept. The language thesaurus, the language table, and the linguistic ontology are collectively referred to as a language database, and, by using the language database when the co-occurring word extracting section 113 obtains the co-occurrence relation between the metadata of contents, the process may be performed by regarding words differently noted as the same words or related words with the similarity being lowered.

### Modification 3

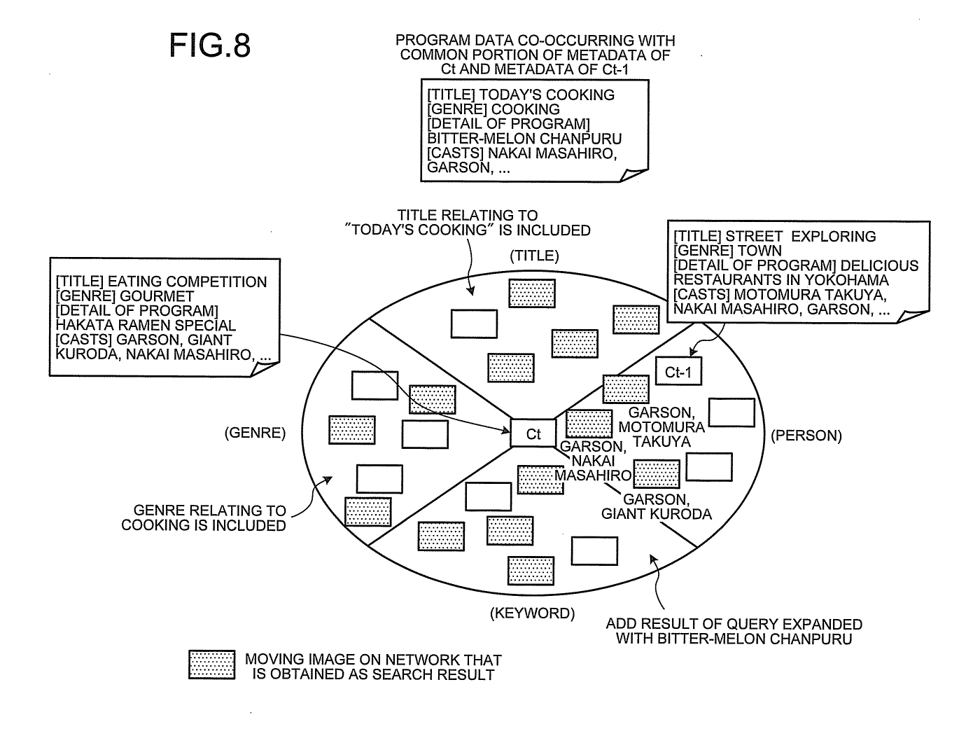

FIG. 8 is a diagram illustrating an example of a display screen of content information at time t (at the current time), according to a modification of this embodiment. The feature of this modification is in that the method of generating a search query used for arranging contents between the central content information Ct and the immediately previous content information Ct−1 is different.

First, the co-occurring word extracting section 113 extracts program metadata that includes at least a part of a common portion of the metadata of Ct and the metadata of Ct−1. In the example illustrated in FIG. 8, although common portions of Ct−1 and Ct are casts “Nakai Masahiro” and “Garson,” as one of the program metadata including these words, a content program “Today's Cooking” is extracted. In this metadata, a title “Today's Cooking,” a genre “Cooking,” a keyword “Bitter-Melon Chanpuru” are included. In addition, in each display area, content information including a title relating to “Today's Cooking,” content information including a genre relating to “Cooking,” and content information searched for with a query that is expanded with a keyword “Bitter-Melon Chanpuru,” for example, a search result of a moving image on the network are displayed.

Next, for a word included in the metadata that is stored in the storage 102 in advance, similarly to the first embodiment, a query used for arranging content information between Ct and Ct−1 is generated.

In addition, a query acquired by adding a co-occurring word to the common portion of the metadata of the contents Ct−1 and Ct, which is extracted by the co-occurring word extracting section 113, is generated, and the content information is arranged in accordance with the metadata collected by the content collecting section 112. In this process, particularly, even in a case where program information is hardly written in Ct, some sort of keyword is added, and accordingly, this is effective in a case where a content to be arranged at time t+1 cannot be acquired when this process is not performed.

In this manner, for a content selecting and watching operation performed by a user, a sufficient amount of related contents can be recommended.

In the above-described embodiment, although the content recommendation device 100 is supposed to be used in a terminal, which is owned and operated by the user, such as a personal computer, a television set, or a cellular phone, a case may be similarly applied in which only a portion relating to the content display and the content selection is used in the terminal owned and operated by the user, and the other portions are used in a server that is connected thereto through a wired or wireless network.

For example, the content recommendation device 100 may be implemented by using a general-purpose computer device as its basic hardware. In other words, the control unit 101, the keyword extracting unit 103, the arrangement determining unit 104, the content acquiring unit 105, the arrangement control unit 106, the content display unit 107, and the content selecting unit 108 can be implemented by executing a program in a processor that is built in a general-purpose computer device. At this time, the content recommendation device 100 may be implemented by installing the above-described program in the computer device in advance or be implemented by storing the above-described program in a storage medium such as a CD-ROM or distributing the above-described program through a network and appropriately installing the program to the computer device. In addition, the storage 102 may be implemented by appropriately using a memory or a hard disk that is built in or externally attached to the above-described computer device, a storage medium such as a CD-ROM, or the like.

According to the embodiment, there can be provided a content recommendation device, it is possible to recommend to a user that there are contents relating to both a content currently displayed and a content previously displayed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content recommendation device comprising:
a storage configured to store therein metadata of a plurality of contents;
a display unit configured to display a plurality of pieces of content information corresponding to the contents, the content information are recognizable by a user;
a selection unit configured to select first content information displayed on the display unit and second content information to be displayed after the first content information;
an extraction unit configured to extract a keyword based on a co-occurrence relation between the metadata of the first content information and the metadata of the second content information;
a generation unit configured to generate a search query based on the keyword;
an acquisition unit configured to acquire third content information from an external database using the search query;
a calculation unit configured to calculate similarity between the second content information and the third content information by using the metadata of the second and third content information; and
an arrangement control unit configured to arrange the third content information on the display unit based on the similarity.

2. The device according to claim 1, wherein the arrangement control unit arranges the third content information closer to the second content information as the similarity is higher.

3. The device according to claim 1, wherein the extraction unit extracts the keyword by using a language database.

4. A method of recommending a content, the method comprising:
storing metadata of a plurality of contents in a storage;
displaying a plurality of pieces of content information corresponding to the contents on a display unit, the content information are recognizable by a user;
selecting first content information displayed on the display unit and second content information to be displayed after the first content information;
extracting a keyword based on a co-occurrence relation between the metadata of the first content information and the metadata of the second content information;
generating a search query based on the keyword;
acquiring third content information from an external database using the search query;
calculating similarity between the second content information and the third content information by using the metadata of the second and third content information; and
arranging the third content information on the display unit based on the similarity.

5. A computer program product comprising a computer-readable medium including programmed instructions, wherein the instructions, when executed by a computer, cause the computer to perform:
storing metadata of a plurality of contents in a storage;
displaying a plurality of pieces of content information corresponding to the contents on a display unit, the content information are recognizable by a user;
selecting first content information displayed on the display unit and second content information to be displayed after the first content information;
extracting a keyword based on a co-occurrence relation between the metadata of the first content information and the metadata of the second content information;
generating a search query based on the keyword;
acquiring third content information from an external database using the search query;
calculating similarity between the second content information and the third content information by using the metadata of the second and third content information; and
arranging the third content information on the display unit based on the similarity.
